(19) United States
(12) Patent Application Publication
(10) Pub. No.: US 2011/0051243 A1
(43) Pub. Date: Mar. 3, 2011

(54) PRISM TYPE LENS STRUCTURE

(76) Inventor: Yu-Hsiu SU, HsinChu (TW)

(21) Appl. No.: 12/646,374

(22) Filed: Dec. 23, 2009

(30) Foreign Application Priority Data
Aug. 28, 2009 (TW) 098215910

(51) Int. Cl. G02B 27/64

(52) U.S. Cl. 359/555

(57) ABSTRACT

A prism type lens structure is provided. A plurality of piezoelectric elements are mounted to a reflection prism. The deformation of piezoelectric elements corresponding to the applied voltages controls the deflection angle of the reflection prism to compensate the unsteady optical path caused by vibration. Therefore, the image of light signals may be controlled to precisely and steadily focus in an image sensor element to reduce the vibration due to hand shake.

### BACKGROUND OF THE INVENTION

1. Field of the Invention

The present invention relates to a prism type lens structure, particularly to a prism type lens structure with vibration reduction capability.

2. Description of the Prior Art

The image capturing devices, such as the mobile phones and the PDA with image capturing capability, the digital cameras and so on, are now becoming popular and have brought a lot of convenience to people. A prism type lens structure includes a lens set concealed within the case of the image capturing device and a total reflection prism used to deflect the incident light by 90° to make the incident light in a direction along the optical axis of the lens set and guide the incident light into the lens set, wherein the focal distance of the lens set is adjusted by moving the lens set up or down. In this design of the prism type lens structure, because the lens set is not protruded out of the case of the image capturing device, the size and the thickness of the image capturing devices may be substantially decreased to have the advantages of more compact appearance and better portability.

However, the image capturing devices with prism type lens structure are very sensitive to the vibration. During capturing the pictures, the vibration caused by hand-shake will cause the movement of the light signals on the image sensor element after passing through the camera lens, so as to result in blur images. One of the common methods for vibration reduction includes adopting a compensational lens set specialized for vibration reduction in the camera lens, and adjusting the position and angle of the compensational lens set according to the direction and the degree of the vibration, so as to maintain a steady optical path. However, this method for vibration reduction requires the specialized compensational lens set and results in an increase in size and weight of the image capturing devices and disadvantage for compact design trend.

### SUMMARY OF THE INVENTION

The present invention is directed to provide a prism type lens structure that may control the deflection angle of the total reflection prism by adopting piezoelectric elements that may be controlled in their deformation with voltage variation to compensate the unstable optical path caused by hand shake. Therefore, the light signals may steadily transmit to the image sensor element to achieve the purpose of the vibration reduction.

According to an embodiment, a prism type lens structure comprises an optical lens set comprising at least one lens configured along an optical axis; an image sensor element configured below the optical lens set; a reflective element movably configured above the optical lens set for guiding a light signal along the optical axis of the optical lens set to image on the image sensor element; and a vibration reduction device comprising at least three piezoelectric elements distributively mounted to the reflective element; and a control mechanism electrically connected to the piezoelectric elements for detecting a vibration and applying a corresponding voltage to the piezoelectric elements for controlling a deflection angle of the reflective element.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram illustrating a prism type lens structure according to one embodiment of the present invention;

FIG. 2 is a schematic diagram illustrating a prism type lens structure with four sets of piezoelectric elements configured on a total reflection prism according to one embodiment of the present invention; and

FIG. 3 is a schematic diagram illustrating a prism type lens structure in practice according to one embodiment of the present invention.

### DESCRIPTION OF THE PREFERRED EMBODIMENT

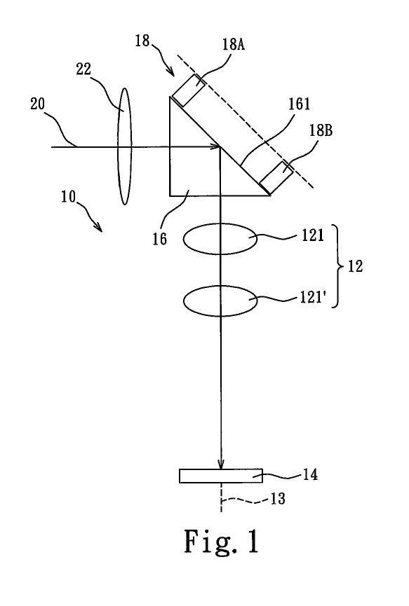

FIG. 1 is a schematic diagram illustrating a prism type lens structure according to an embodiment of the present invention. A prism type lens structure may be applied in stand-alone digital cameras or the camera modules in other electronics, e.g. the mobile phones. In this embodiment, the prism type lens structure 10 includes an optical lens set 12, an image sensor element 14, a reflective element, and a vibration reduction device. In this embodiment, the reflective element is a total reflection prism 16; the vibration reduction device includes a plurality of the piezoelectric elements 18 (including 18A and 18B) and a control mechanism (not illustrated).

In one embodiment, the optical lens set 12 includes two sets of the lenses 121, 121′ configured along an optical axis 13. The image sensor element 14, e.g. a CMOS or a CCD image sensor, is configured below the optical lens set 12 along the optical axis 13 of the optical lens set 12. The total reflection prism 16 is movably configured above the optical lens set 12, and an included angle of 45° is between a reflection mirror 161 of the total reflection prism 16 and the optical axis 13 of the optical lens set 12 for receiving the light and guiding the light in the direction of the optical axis 13 of the optical lens set 12.

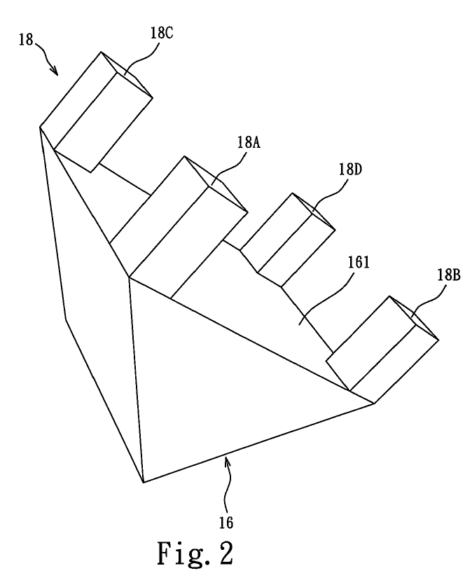

A plurality of the piezoelectric elements 18 are mounted to the total reflection prism 16. In this embodiment, a plurality of the piezoelectric elements 18 are configured at an outer surface of the reflection mirror 161 of the total reflection prism 16, wherein the inner surface of the reflection mirror 161 is a reflective surface, and the reflection mirror 161 presents a tetragonal shape, as illustrated in FIG. 2. In this embodiment, four sets of the piezoelectric elements 18 are respectively configured at each corner of the outer surface of the tetragonal reflection mirror 161 and electrically connected to the control mechanism. The control mechanism may detect the horizontal and/or the vertical vibration of the camera and applying corresponding voltage to at least portions of the piezoelectric elements 18. The shapes of the piezoelectric elements 18 are deformed due to the converse piezoelectric effect to propel the total reflection prism 16 with controlled deflection angle.

In this embodiment, these four sets of the piezoelectric elements 18 are respectively denominated as 18A, 18B, 18C, 18D, where the piezoelectric elements 18A, 18C and the piezoelectric elements 18B, 18D are respectively arranged in horizontal directions; the piezoelectric elements 18A, 18B and the piezoelectric elements 18C, 18D are respectively arranged in vertical directions. In the case of normal status, i.e. without vibration present, the piezoelectric elements 18A, 18B, 18C, 18D remain their original shapes, where FIG. 1 illustrates the piezoelectric elements 18A, 18B only. A light signal 20 enters the total reflection prism 16 through an objective lens 22, and deflected 90° by the total reflection prism 16 into the optical lens set 12 and then focused on the image sensor element 14 through an adjustment of the optical lens set 12.

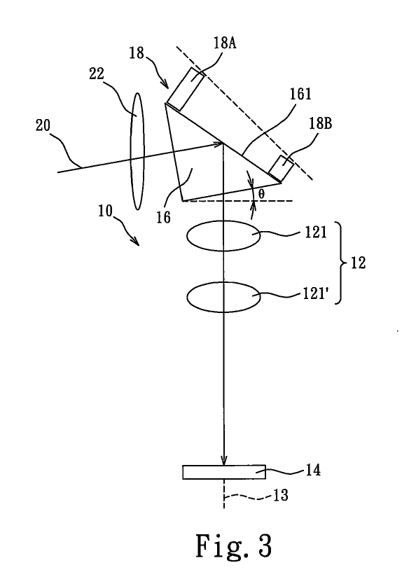

When the camera is vibrated vertically due to the hand shake, the image on the image sensor element 14 would vibrate vertically as well, and the control mechanism turns on one set of the piezoelectric elements including the piezoelectric elements 18A, 18C, and the other set of the piezoelectric elements including the piezoelectric element 18B, 18D. As illustrated in FIG. 3, the piezoelectric elements 18A, 18C are elongated while the piezoelectric elements 18B, 18D remain still or are slightly prolonged. As illustrated, the piezoelectric elements 18A, 18C are elongated more than the piezoelectric elements 18B, 18D. For simplification and clarification, this embodiment exemplifies vertical vibration only and illustrates the piezoelectric elements 18A, 18B; however, the piezoelectric elements 18C and the piezoelectric elements 18D would respectively actuate corresponding to the piezoelectric elements 18A and the piezoelectric elements 18B. In this embodiment, the combined deformation of these piezoelectric elements 18A, 18B, 18C, 18D results in an inclination angle θ of the total reflection prism 16. The inclination angle θ in this way compensates the optical path shift caused by the vibration, so that the light may steadily travels along the optical axis 13 of the optical lens set 12 and may steadily image on the image sensor element 14. Likewise, when the camera is vibrated horizontally due to the hand shake, the control mechanism turns on one set of the piezoelectric elements including the piezoelectric elements 18A, 18B, and the other set of the piezoelectric elements including the piezoelectric element 18C, 18D to control the rotation angle of the total reflection prism 16 so that the light may steadily image on the image sensor element 14. The control mechanism may be used for detecting vertical and horizontal vibration and applying corresponding voltage to the piezoelectric elements 18A, 18B, 18C, 18D for compensating any shift in deflection angle, including the inclination angle or the rotation angle, so that the total vibration reduction may thus be achieved.

Here, the piezoelectric elements may be made of the piezoelectric ceramics and have no limitation in quantity. For example, there may be three or more piezoelectric elements. The control mechanism may adjust the weighted voltage based on the material and quantity of the piezoelectric elements and apply the appropriate voltage to the piezoelectric elements, so as to completely control the inclination angle and the rotation angle of the reflective element.

In addition, due to the nature of total light reflection, the optical path is deflected by an angle, and the angle is twice as the deflection angle of the total reflection prism; i.e. there is more shift in the image on the image sensor element. Therefore, the vibration reduction device of the present invention may adjust image position more by adjusting the deflection angle of the total reflection prism less.

To sum up, the present invention may control the deflection angle of the reflective element by adopting the piezoelectric elements that may be controlled in their deformation with voltage variation, to compensate the unstable optical path caused by hand shake. Therefore, the light signals may steadily transmit to the image sensor element to achieve the purpose of the vibration reduction.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A prism type lens structure, comprising:
an optical lens set comprising at least one lens configured along an optical axis;
an image sensor element configured below said optical lens set;
a reflective element movably configured above said optical lens set for guiding a light signal along said optical axis of said optical lens set to image on said image sensor element; and
a vibration reduction device comprising:
at least three piezoelectric elements distributively mounted to said reflective element; and
a control mechanism electrically connected to said piezoelectric elements for detecting a vibration and applying a corresponding voltage to said piezoelectric elements for controlling a deflection angle of said reflective element.

2. The prism type lens structure as claimed in claim 1, wherein said reflective element comprises a total reflection prism.

3. The prism type lens structure as claimed in claim 1, wherein said reflective element comprises a tetragonal reflection mirror.

4. The prism type lens structure as claimed in claim 3, wherein said piezoelectric elements are respectively configured at each corner of an outer surface of said tetragonal reflection mirror.

5. The prism type lens structure as claimed in claim 3, wherein an included angle of 45° is between said tetragonal reflection mirror and said optical axis of said optical lens.

6. The prism type lens structure as claimed in claim 1, wherein said piezoelectric elements are made of piezoelectric ceramics.
